(19) United States
(12) Patent Application Publication
(10) Pub. No.: US 2021/0086790 A1
(43) Pub. Date: Mar. 25, 2021

(54) METHOD FOR DRIVING A MOTOR VEHICLE IN AT LEAST PARTIALLY AUTOMATED FASHION

(71) Applicant: Robert Bosch GmbH, Stuttgart (DE)

(72) Inventor: Stefan Nordbruch, Kornwestheim (DE)

(21) Appl. No.: 17/018,202

(22) Filed: Sep. 11, 2020

(30) Foreign Application Priority Data
Sep. 23, 2019 (DE) 102019214413.6

(51) Int. Cl. B60W 60/00; G05D 1/00; B60W 30/18; G06F 21/60

(52) U.S. Cl. CPC B60W 60/0015; G05D 1/0088; B60W 30/18163; G05D 1/0022; G05D 1/0055; B60W 2756/10; B60W 2554/802; B60W 2520/105; B60W 2754/30; B60W 2555/60; G06F 21/602

(57) ABSTRACT

A method for driving a motor vehicle in at least partially automated fashion. The method includes: receiving operating condition signals, which represent an operating condition for the motor vehicle, which must be fulfilled so that the motor vehicle may be driven in at least partially automated fashion, receiving state signals, which represent a state of the motor vehicle and/or of its surroundings, checking on the basis of the state whether the operating condition is fulfilled in order to ascertain a result of the check, generating control signals for controlling a lateral and/or longitudinal guidance of the motor vehicle in at least partially automated fashion based on the result of the check in order to drive the motor vehicle on the basis of the generated control signals in at least partially automated fashion, outputting the generated control signals. A device, a computer program and a machine-readable storage medium are also described.

### CROSS REFERENCE

The present application claims the benefit under 35 U.S.C. § 119 of German Patent Application No. DE 102019214413.6 filed on Sep. 23, 2019, which is expressly incorporated herein by reference in its entirety.

### FIELD

The present invention relates to a method for driving a motor vehicle in at least partially automated fashion. The present invention further relates to a device, to a computer program and to a machine-readable storage medium.

### BACKGROUND INFORMATION

German Patent Application No. DE 10 2018 120 845 A1 describes a method and a device for monitoring an autonomous vehicle.

German Patent Application No. DE 10 2018 129 066 A1 describes systems and methods for unprotected left turns in autonomous vehicles in situations with high traffic volume.

German Patent Application DE 11 2016 005 335 T5 and PCT Application No. WO 2017/086139 describe an automated driving assistance device.

### SUMMARY

An object of the present invention is to provide for efficiently driving a motor vehicle in at least partially automated fashion. This object may be achieved by example embodiments of the present invention. Advantageous developments of the present invention are described herein.

According to a first aspect of the present invention, a method is provided for driving a motor vehicle in at least partially automated fashion. In accordance with an example embodiment of the present invention, the method includes the following steps: receiving operating condition signals, which represent an operating condition for the motor vehicle, which must be fulfilled so that the motor vehicle may be driven in at least partially automated fashion,

receiving state signals, which represent a state of the motor vehicle and/or of its surroundings,
checking on the basis of the state whether the operating condition is fulfilled in order to ascertain a result of the check,
generating control signals for controlling a lateral and/or longitudinal guidance of the motor vehicle in at least partially automated fashion based on the result of the check in order to drive the motor vehicle on the basis of the generated control signals in at least partially automated fashion, outputting the generated control signals.

According to a second aspect of the present invention, a device is provided, which is designed to perform all steps of the method according to the first aspect.

According to a third aspect of the present invention, a computer program is provided, which comprises commands, which prompt a computer, for example the device according to the second aspect, when executing the computer program, to implement a method according to the first aspect.

According to a fourth aspect of the present invention, a machine-readable storage medium is provided, on which the computer program according to the third aspect is stored.

According to a fifth aspect of the present invention, a motor vehicle is provided, which comprises the device according to the second aspect.

In accordance with an example embodiment of the present invention, the motor vehicle is driven in at least partially automated fashion only if the operating condition is fulfilled in the concretely existing state.

Normally, motor vehicles that are able to be driven in at least partially automated fashion were designed and/or developed and produced only for specific situations and/or states. Such situations comprise for example driving on a freeway, driving in an urban space, driving in a logistics yard, driving within a parking facility.

In the development and production of such a motor vehicle, it is then assumed for example that specific conditions exist and/or a specific state exists within the situation. For this situation and/or for this state, the motor vehicle is then accordingly designed to be driven in at least partially automated fashion.

However, if the concretely existing state and/or the concretely existing situation should deviate from the original situation for which the motor vehicle was developed, then an at least partially automated drive of the motor vehicle in such a situation could result in a risk and/or in unsafe driving.

Checking concretely whether the motor vehicle is further designed for the concretely existing situation and/or the concretely existing state in order to be driven in at least partially automated fashion makes it possible efficiently and advantageously to reduce and/or prevent a risk of an accident for the motor vehicle.

In a development and production, that is, when designing the motor vehicle, laws, but also a failure to comply with laws, are taken into account, for example. It must be assumed, for example, that other road users travel at a higher speed than the permitted maximum speed. In order to be able to react to such a situation, higher standards are set and/or taken into account for respective driver assistance systems. For example, driver assistance systems must also react to motor vehicles in the environment of the motor vehicle, which are very much faster than the motor vehicle itself. Costs for the development and production of the motor vehicle may rise as a result. Furthermore, a technical expenditure in the development of a corresponding driver assistance system may also rise as a result. Furthermore, a corresponding driver assistance system and/or generally a motor vehicle system, in particular the brake, passive safety system etc., requires for example a high processing and memory capacity.

It is thus, in accordance with an example embodiment of the present invention, the motor vehicle is developed only for specific premises/conditions (states), possibly in particular with a predetermined buffer, which is in particular smaller than the normal premises and conditions.

In accordance with an example embodiment of the present invention, a check is performed to determine whether the premises and/or conditions, which are stored for the motor vehicle, are adhered to in the concretely existing situation and/or state.

If this is not the case, actions are initiated for example, which limit the functionality of the motor vehicle for example. A limitation may go as far as a stop or halt of the motor vehicle.

The technical advantage may thus be produced of providing for driving a motor vehicle efficiently in at least partially automated fashion.

A state of the motor vehicle indicates or represents for example one or several of the following items of information: current motor vehicle speed, current motor vehicle acceleration, current motor vehicle position, operating temperature of a drive motor, oil pressure, tire pressure, current total load of the motor vehicle, planned behavior of the motor vehicle (in particular planned motor vehicle speed, planned motor vehicle acceleration, planned motor vehicle position, planned turn), drive type, that is, which drive motor type (electric motor, combustion engine, in particular fuel engine, hybrid drive), drives the motor vehicle currently and/or is planned to drive the motor vehicle, battery state of a battery of the motor vehicle, in particular the state of charge.

According to one specific embodiment of the present invention, a state of a surroundings of the motor vehicle indicates or represents one or several of the following items of information: current and/or predicted position (in particular relative to a traffic lane) of a road user in the environment of the motor vehicle, current and/or predicted acceleration of a road user in the environment of the motor vehicle, current and/or predicted speed of a road user in the environment of the motor vehicle, current and/or predicted behavior (a behavior may comprise a turn, for example) of a road user in the environment of the motor vehicle, weather, time of day, light conditions, state of the lighting system, in particular activated or deactivated, of a lighting system of a road user, in particular of a motor vehicle lighting system of another motor vehicle, in the environment of the motor vehicle.

Information, which is described in connection with the state of the surroundings of the motor vehicle, may analogously apply also to the state of the motor vehicle and vice versa.

According to one specific embodiment of the present invention, a road user is another motor vehicle, a motorcycle, a pedestrian or a bicycle rider.

State signals, which represent a surroundings of the motor vehicle, comprise for example surroundings signals, which represent the surroundings of the motor vehicle.

According to one specific embodiment of the present invention, surroundings signals comprise environment sensor data from one or multiple environment sensors.

An environment sensor is for example associated with the motor vehicle. An environment sensor is for example associated with a road user. An environment sensor is for example associated with an infrastructure, within which the motor vehicle is traveling and/or within which the motor vehicle is located.

An environment sensor is for example one of the following environment sensors: radar sensor, lidar sensor, ultrasonic sensor, magnetic field sensor, video sensor and infrared sensor. Environment sensor data comprise for example environment sensor raw data. Environment sensor data comprise for example processed, for example evaluated, environment sensor raw data.

A motor vehicle is for example a shuttle.

One specific embodiment of the present invention provides for the motor vehicle to have a specific functionality with respect to the at least partially automated driving, the specific functionality being limited if the result indicates that the condition is not fulfilled, the control signals being produced on the basis of the limited specific functionality instead of on the unlimited specific functionality in order to drive the motor vehicle in at least partially automated fashion on the basis of the limited specific functionality.

This yields for example the technical advantage of allowing the motor vehicle to be driven efficiently in at least partially automated fashion. Limiting the functionality yields in particular the technical advantage of making it possible to avoid unsafe situations.

One specific embodiment of the present invention provides for the specific functionality to comprise a first maximum motor vehicle speed and/or first maximum motor vehicle acceleration, which the motor vehicle may maximally exhibit when it is driven in at least partially automated fashion, the limitation of the specific functionality comprising a definition of a second maximum motor vehicle speed and/or second maximum motor vehicle acceleration, which is lower than the first maximum motor vehicle speed and/or first maximum motor vehicle acceleration so that the limited specific functionality comprises the second maximum motor vehicle speed and/or the second maximum motor vehicle acceleration.

This may yield, for example, the technical advantage of efficiently increasing a reaction time of the motor vehicle in dangerous situations with respect to the limited specific functionality due to the lower maximum motor vehicle speed and/or lower maximum motor vehicle acceleration.

One specific embodiment of the present invention provides for the specific functionality to comprise a first minimum distance of the motor vehicle from a preceding road user, in particular from a road user traveling ahead, in particular a motor vehicle, which the motor vehicle must maintain if it is driven in at least partially automated fashion, the limitation of the specific functionality comprising a definition of a second minimum distance, which is greater than the first minimum distance so that the limited specific functionality comprises the second minimum distance.

This yields for example the technical advantage of efficiently increasing a reaction time of the motor vehicle in dangerous situations with respect to the limited specific functionality due to the greater minimum distance.

One specific embodiment of the present invention provides for the specific functionality to comprise a passing function so that the motor vehicle is able to perform a passing maneuver in at least partially automated fashion, the limitation of the specific functionality comprising a limitation or blocking of the passing functionality so that the limited specific functionality comprises the limited passing functionality or excludes the passing functionality.

This yields for example the technical advantage that dangerous situations, as may occur for example during a passing maneuver, may be efficiently reduced or even avoided entirely.

One specific embodiment of the present invention provides for result signals to be generated and output, which represent the result of the check.

This yields for example the technical advantage of allowing the result of the check to be provided efficiently.

One specific embodiment of the present invention provides for the output of the result signals to comprise a transmission of the result signals via a communication network.

This yields for example the technical advantage of allowing the result to be provided remotely. A communication network comprises for example a wireless communication network, which comprises for example a WLAN communication network and/or a mobile telephony network.

For example, the result signals are transmitted to one or multiple network addresses of the communication network.

A network address is for example associated with a road user.

A network address is for example associated with a terminal device, which is carried by the road user.

A terminal device is for example a mobile terminal device, in particular a mobile telephone.

A network address is for example associated with an infrastructure, within which the motor vehicle is located.

One specific embodiment of the present invention provides for the operating condition to specify that the motor vehicle may be driven in at least partially automated fashion only within a predetermined limited geographic area, the state indicating a current position of the motor vehicle, the check comprising checking whether the current position of the motor vehicle is within the predetermined limited geographic area.

This may yield, for example, the technical advantage of making it possible efficiently to ensure that the motor vehicle is driven in at least partially automated fashion only within the predetermined limited geographic area.

One specific embodiment of the present invention provides for the operating condition to specify a maximum speed for road users in the environment of the motor vehicle, which the road users may maximally exhibit so that the motor vehicle is permitted to drive in at least partially automated fashion in the environment of road users, the state indicating a current speed of a road user in the environment of the motor vehicle, the check comprising a check to determine whether the current speed of the road user is lower than or lower than/equal to the maximum speed.

This may yield, for example, the technical advantage that the motor vehicle is driven in at least partially automated fashion only if road users in the environment of the motor vehicle maximally have a predetermined speed, here the maximum speed.

One specific embodiment of the present invention provides for the operating condition to specify a maximum acceleration for road users in the environment of the motor vehicle, which the road users may maximally exhibit so that the motor vehicle is permitted to drive in at least partially automated fashion in the environment of road users, the state indicating a current acceleration of a road user in the environment of the motor vehicle, the check comprising a check to determine whether the current acceleration of the road user is lower than or lower than/equal to the maximum acceleration.

This may yield, for example, the technical advantage that the motor vehicle is driven in at least partially automated fashion only if road users in the environment of the motor vehicle maximally have a predetermined acceleration, here the maximum acceleration.

One specific embodiment of the present invention provides that, if the result indicates that the condition is not fulfilled, the control signals are generated in such a way that the motor vehicle stops, in particular within a predetermined space, when the lateral and/or longitudinal guidance of the motor vehicle is controlled on the basis of the generated control signals.

This may yield, for example, the technical advantage of allowing the motor vehicle to be transferred efficiently into a safe state: the stopped state.

According to one specific embodiment of the present invention, the predetermined space is a safety space within the infrastructure.

According to one specific embodiment of the present invention, a predetermined limited geographic area is defined or stipulated, within which the motor vehicle is located.

The area comprises for example the infrastructure.

One specific embodiment of the present invention provides for the area to comprise a harbor and/or a parking facility.

The infrastructure comprises for example a harbor and/or a parking facility.

In one specific embodiment of the present invention, an infrastructure is provided, within which the motor vehicle is located.

One specific embodiment of the present invention provides for one or multiple method steps to be performed within the vehicle and/or outside the vehicle, for example in an additional motor vehicle and/or in an infrastructure, in particular in a cloud infrastructure.

This may yield, for example, the technical advantage of allowing the method steps to be performed redundantly for example.

One specific embodiment of the present invention provides for one or multiple method steps to be performed by a further motor vehicle only if the further motor vehicle is located within the same predetermined limited geographic area as the motor vehicle.

This may yield, for example, the technical advantage that one or multiple method steps are performed only by the particular additional motor vehicle that is relevant for the motor vehicle with respect to driving the motor vehicle in at least partially automated fashion.

One specific embodiment of the present invention provides for data, which are used for performing one or multiple method steps, to be exchanged and/or provided between the exterior of the motor vehicle and the interior of the motor vehicle.

This may yield, for example, the technical advantage of making it possible that the entities that perform the method steps receive the data in an efficient manner. These entities thus comprise in particular an additional motor vehicle, the infrastructure, in particular the cloud infrastructure, generally a road user and the motor vehicle itself. The interior of the motor vehicle thus refers to the motor vehicle itself. The exterior of the motor vehicle thus refers in particular to an entity that is distinct from the motor vehicle and is external to the motor vehicle.

Data in the sense of this specific embodiment comprise for example environment sensor data. Data comprise for example one or multiple items of information regarding the state of the motor vehicle and/or the state of the surroundings of the motor vehicle. Data comprise for example the result. Data comprise for example the control signals. Data comprise for example intermediate results.

One specific embodiment of the present invention provides for one or multiple method steps to be documented, in particular documented in a blockchain.

This may yield, for example, the technical advantage of making it possible to analyze the performance and/or implementation of the method even after the fact, that is, after an implementation and/or execution of the method. The documentation in a blockchain yields in particular the technical advantage that the documentation may be performed in a manner that is secured against forgery and manipulation.

A blockchain (also block chain) is a continuously expandable list of data sets, called “blocks”, which are linked to one another by one or multiple cryptographic methods. Each block contains in particular a cryptographically secure hash (erratic value) of the preceding block, in particular a time stamp and in particular transaction data.

One specific embodiment of the present invention provides for the method according to the first aspect to be executed or carried out using the device according to the second aspect.

Method features of the present invention derive in an analogous manner from corresponding device features of the present invention and vice versa.

That is to say in particular that technical functionalities of the method according to the first aspect result from corresponding technical functionalities of the device according to the second aspect and vice versa.

The formulation “at least one” stands in particular for “one or several.”

One specific embodiment of the present invention provides for the method according to the first aspect to be a computer-implemented method.

The formulation “driving in at least partially automated fashion” comprises one or several of the following cases: assisted driving, partially automated driving, highly automated driving, fully automated driving.

Assisted driving means that a driver of the motor vehicle permanently performs either the lateral or the longitudinal guidance of the motor vehicle. The respectively other driving task (that is, controlling the longitudinal or the lateral guidance of the motor vehicle) is performed automatically. That is to say that in assisted driving of the motor vehicle either the lateral guidance or the longitudinal guidance is controlled automatically.

Partially automated driving means that in a specific situation (for example: driving on a freeway, driving within a parking facility, passing an object, driving within a traffic lane, which is defined by lane markers) and/or for a certain time period a longitudinal guidance and a lateral guidance of the motor vehicle are controlled automatically. It is not necessary for a driver of the motor vehicle to control the longitudinal and lateral guidance of the motor vehicle manually. Nevertheless, the driver must permanently monitor the automatic control of the longitudinal and lateral guidance so as to be able to intervene manually when necessary. The driver must always be prepared to take complete control of driving the motor vehicle.

Highly automated driving means that for a certain time period in a specific situation (for example: driving on a freeway, driving within a parking facility, passing an object, driving within a traffic lane, which is defined by lane markers) a longitudinal guidance and a lateral guidance of the motor vehicle are controlled automatically. It is not necessary for a driver of the motor vehicle to control the longitudinal and lateral guidance of the motor vehicle manually. It is not necessary for the driver permanently to monitor the automatic control of the longitudinal and lateral guidance so as to be able to intervene manually when necessary. When necessary, a takeover request is automatically output to the driver for taking over the control of the longitudinal and lateral guidance, in particular with sufficient time to respond. Thus, the driver must be potentially able to take control of longitudinal and lateral guidance. Limits of the automatic control of the lateral and longitudinal guidance are detected automatically. In highly automated driving, it is not possible in every initial situation to bring about a risk-minimized state automatically.

Fully automated driving means that in a specific situation (for example: driving on a freeway, driving within a parking facility, passing an object, driving within a traffic lane, which is defined by lane markers) a longitudinal guidance and a lateral guidance of the motor vehicle are controlled automatically. It is not necessary for a driver of the motor vehicle to control the longitudinal and lateral guidance of the motor vehicle manually. It is not necessary for the driver to monitor the automatic control of the longitudinal and lateral guidance so as to be able to intervene manually when necessary. Prior to a termination of the automatic control of the lateral and longitudinal guidance, a request is automatically output to the driver to take over the task of driving (controlling the lateral and longitudinal guidance of the motor vehicle), in particular with sufficient time to respond. If the driver does not take over the task of driving, the motor vehicle is automatically returned to a risk-minimized state. Limits of the automatic control of the lateral and longitudinal guidance are detected automatically. In all situations it is possible to return the motor vehicle automatically to a risk-minimized system state.

The terms area and space may be used synonymously.

One specific embodiment of the present invention provides for the control signals to comprise and/or be at least in part remote control signals for controlling the lateral and/or longitudinal guidance of the motor vehicle remotely in order to control the lateral and/or longitudinal guidance of the motor vehicle remotely when the motor vehicle is controlled remotely on the basis of the remote control signals.

This may yield, for example, the technical advantage of allowing the motor vehicle to be controlled remotely in an efficient manner. This yields in particular the technical advantage of allowing the motor vehicle to be controlled remotely in an efficient manner.

In the event that the remote control signals comprise control signals for controlling the lateral or the longitudinal guidance of the motor vehicle, one specific embodiment provides for the respective other guidance, that is, the longitudinal guidance or the lateral guidance, to be controlled either manually (which may then be called in particular assisted driving) or to be controlled at least in partially automated fashion in order to drive the motor vehicle at least in partially automated fashion.

Assisted driving means in this case that a driver of the motor vehicle permanently performs either the lateral or the longitudinal guidance of the motor vehicle. The respectively other driving task (that is, controlling the longitudinal or the lateral guidance of the motor vehicle) is automatically performed remotely. That is to say that in assisted driving of the motor vehicle either the lateral guidance or the longitudinal guidance is automatically controlled remotely.

The formulation “at least partially automated driving” then comprises in this case, that is, when the lateral or longitudinal guidance is controlled remotely, one or several of the following cases: partially automated driving, highly automated driving, fully automated driving.

Partially automated driving means that in a specific situation (for example: driving on a freeway, driving within a parking facility, passing an object, driving within a traffic lane, which is defined by lane markers) and/or for a certain time period a longitudinal guidance and a lateral guidance of the motor vehicle are automatically controlled remotely. It is not necessary for a driver of the motor vehicle to control the longitudinal and lateral guidance of the motor vehicle manually. Nevertheless, the driver must permanently monitor the automatic remote control of the longitudinal and lateral guidance so as to be able to intervene manually when necessary. The driver must always be prepared to take complete control of driving the motor vehicle.

Highly automated driving means that for a certain time period in a specific situation (for example: driving on a freeway, driving within a parking facility, passing an object, driving within a traffic lane, which is defined by lane markers) a longitudinal guidance and a lateral guidance of the motor vehicle are automatically controlled remotely. It is not necessary for a driver of the motor vehicle to control the longitudinal and lateral guidance of the motor vehicle manually. It is not necessary for the driver permanently to monitor the automatic remote control of the longitudinal and lateral guidance so as to be able to intervene manually when necessary. When necessary, a takeover request is automatically output to the driver for taking over the control of the longitudinal and lateral guidance, in particular with sufficient time to respond. Thus, the driver must be potentially able to take control of longitudinal and lateral guidance. Limits of the automatic remote control of the lateral and longitudinal guidance are detected automatically. In highly automated driving, it is not possible in every initial situation to bring about a risk-minimized state automatically.

Fully automated driving means that in a specific situation (for example: driving on a freeway, driving within a parking facility, passing an object, driving within a traffic lane, which is defined by lane markers) a longitudinal guidance and a lateral guidance of the motor vehicle are automatically controlled remotely. It is not necessary for a driver of the motor vehicle to control the longitudinal and lateral guidance of the motor vehicle manually. It is not necessary for the driver to monitor the automatic remote control of the longitudinal and lateral guidance so as to be able to intervene manually when necessary. Prior to a termination of the automatic remote control of the lateral and longitudinal guidance, a request is automatically output to the driver to take over the task of driving (controlling the lateral and longitudinal guidance of the motor vehicle), in particular with sufficient time to respond. If the driver does not take over the task of driving, the motor vehicle is automatically returned to a risk-minimized state. Limits of the automatic control of the lateral and longitudinal guidance are detected automatically. In all situations it is possible to return the motor vehicle automatically to a risk-minimized system state.

One specific embodiment of the present invention provides for safety condition signals to be received which represent at least one safety condition that must be fulfilled so that the motor vehicle may be controlled remotely, a check being performed to determine whether the at least one safety condition is fulfilled, the remote control signals being generated based on a result of the check as to whether the at least one safety condition is fulfilled.

This may yield, for example, the technical advantage of allowing the remote control signals to be generated in an efficient manner. In particular, this yields the technical advantage of making it possible to ensure efficiently that specific prerequisites, in the present case the safety condition, are fulfilled for controlling the motor vehicle remotely. This yields in particular the technical advantage that, if the safety condition is fulfilled, it is then possible to control the motor vehicle remotely in a safe manner.

One specific embodiment of the present invention provides for the at least one safety condition to be respectively an element selected from the following group of safety conditions:

existence of a predetermined safety integrity level (SIL) or automotive safety integrity level (ASIL) of at least the motor vehicle and an infrastructure, in particular including a communication link and/or communication components (for example communication interface), for controlling a motor vehicle remotely (in particular with respect to the overall systems in the motor vehicle and infrastructure and in particular parts, e.g. components, algorithms, interfaces, etc.),
existence of a maximum latency of a communication between the motor vehicle and a remote control device for controlling the motor vehicle remotely on the basis of the remote control signals,
existence of a predetermined computer protection level of a device for performing the steps of the method according to the first aspect,
existence of predetermined components and/or algorithms and/or communication options that are used for performing the steps of the method according to the first aspect,
existence of a redundancy and/or diversity in predetermined components and/or algorithms and/or communication options that are used for performing the steps of the method according to the first aspect,
existence of predetermined availability information, which indicates an availability of predetermined components and/or algorithms and/or communication options,
existence of predetermined quality criteria of the predetermined components and/or algorithms and/or communication options,
existence of a plan which comprises measures for reducing errors and/or measures in the event of failures of predetermined components and/or algorithms and/or communication options and/or measures for misdiagnoses and/or measures in the event of misinterpretations,
existence of one or multiple fallback scenarios,
existence of a predetermined function,
existence of a predetermined traffic situation,
existence of a predetermined weather, maximally possible time for a respective performance and/or execution of a step or of multiple steps of the method according to the first aspect, existence of a result of a check to determine that elements and/or functions, which are used for carrying out the method according to the first aspect, currently function in a faultless manner.

A communication link is for example a communication link between the device according to the second aspect and the motor vehicle. A communication link comprises for example one or multiple communication channels.

In one specific embodiment of the present invention, a component, which is used to carry out the method according to the first aspect, is an element selected from the following group of components: environment sensor, motor vehicle, infrastructure, remote control device, device according to the second aspect, motor vehicle system, in particular drive system, clutch system, brake system, driver assistance system, communication interface of the motor vehicle and/or of the infrastructure, processor, input, output of the device according to the second aspect.

In one specific embodiment of the present invention, a function, which is used to carry out the method according to the first aspect, is an element selected from the following group of functions: remote control function, communication function between the motor vehicle and the infrastructure and/or the remote control device, evaluation function of environment sensor data of an environment sensor, planning function, in particular drive planning function, traffic analysis function.

A computer protection level defines in particular the following: activated firewall and/or valid encryption certificate for encrypting a communication between the motor vehicle and the infrastructure and/or the remote control device and/or activated virus program having updated virus signatures and/or existence of a protection, in particular a mechanical protection, in particular a break-in protection, of the computer, in particular of the device according to the second aspect and/or of the remote control device and/or existence of a possibility for checking that signals, in particular remote control signals and/or surroundings signals, were transmitted correctly, that is, error-free.

An algorithm comprises for example the computer program according to the third aspect.

The fact that in particular a check is performed to determine that there exists a redundancy and/or diversity in predetermined components and/or algorithms and/or communication options may yield, for example, the technical advantage that even in the event of a failure of the respective component, for example a computer, and/or of the corresponding algorithm and/or of the corresponding communication option, it is nevertheless possible to execute a safe function.

To ensure that results are correct, it is possible in one specific embodiment to calculate these results multiple times for example and to compare the respective results with one another. Only if there is agreement among the results is it determined for example that the results are correct. If multiple times is an uneven number, it may be provided for example that a determination is made that the result corresponding to the highest number of identical results is correct.

Only if it can be determined that the result is correct are remote control signals generated, for example.

One specific embodiment of the present invention provides for the remote control signals to be generated only if the at least one safety condition is fulfilled.

One specific embodiment of the present invention provides for the check to determine whether the at least one safety condition is fulfilled to occur prior to and/or after and/or during one or several predetermined method steps.

In particular, this yields the technical advantage of making it possible to ensure efficiently that specific prerequisites, in the present case the safety condition, for controlling the motor vehicle remotely are fulfilled prior to and/or after and/or during the performance of the respective method steps. This yields in particular the technical advantage that, if the safety condition is fulfilled, it is then possible to control the motor vehicle remotely in a safe manner.

One specific embodiment of the present invention provides that, following the output of the remote control signals, a remote control of the motor vehicle based on the output remote control signals is checked in order to detect an error, the remote control being aborted in the event that an error is detected or emergency remote control signals for controlling the motor vehicle remotely in an emergency being generated and output.

According to one specific embodiment of the present invention, the emergency remote control signals comprise emergency control signals for controlling the lateral and/or longitudinal guidance of the motor vehicle remotely. The emergency control signals are for example such that when the lateral and/or longitudinal guidance of the motor vehicle are controlled remotely the motor vehicle is transferred to a safe state, in particular stopped.

Explanations provided in connection with the remote control signals, in particular with the control signals, apply analogously to the emergency remote control signals, in particular the emergency control signals, and vice versa.

Exemplary embodiments of the present invention are illustrated in the figures and are explained in greater detail below.

### BRIEF DESCRIPTION OF THE DRAWINGS

FIG. 1 shows a flow chart of a method for driving a motor vehicle in at least partially automated fashion in accordance with an example embodiment of the present invention.

FIG. 2 shows a device in accordance with an example embodiment of the present invention.

FIG. 3 shows a machine-readable storage medium in accordance with an example embodiment of the present invention.

### DETAILED DESCRIPTION OF EXAMPLE EMBODIMENTS

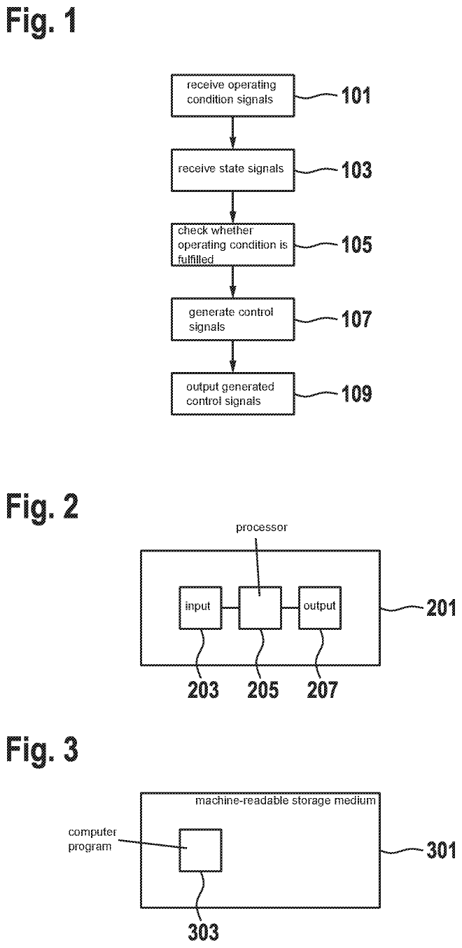

FIG. 1 shows a flow chart of a method in accordance with an example embodiment of the present invention for driving a motor vehicle in at least partially automated fashion, comprising the following steps:

receiving 101 operating condition signals, which represent an operating condition for the motor vehicle, which must be fulfilled so that the motor vehicle may be driven in at least partially automated fashion,
receiving 103 state signals, which represent a state of the motor vehicle and/or of its surroundings,
checking 105 on the basis of the state whether the operating condition is fulfilled in order to ascertain a result of the check,
generating 107 control signals for controlling a lateral and/or longitudinal guidance of the motor vehicle in at least partially automated fashion based on the result of the check in order to drive the motor vehicle on the basis of the generated control signals in at least partially automated fashion,
outputting 109 the generated control signals.

One specific embodiment of the present invention provides for the method according to the first aspect to comprise a step of controlling the lateral and/or longitudinal guidance of the motor vehicle based on the generated control signals.

FIG. 2 shows a device 201 in accordance with an example embodiment of the present invention.

Device 201 is designed to perform all of the steps of the method according to the first aspect.

Device 201 comprises an input 203, which is designed to receive the operating condition signals and the state signals.

Device 201 comprises a processor 205, which is designed to check on the basis of the state whether the operating condition is fulfilled in order to ascertain a result of the check. Processor 205 is furthermore designed to generate the control signals.

Device 201 further comprises an output 207, which is designed to output the generated control signals.

Generally, it is provided for example that signals that are received are received by way of input 203. Accordingly, input 203 is thus designed in particular to receive these signals.

Generally, it is provided for example that signals that are output are output by way of output 207. That is to say in particular that output 207 is in particular designed to output the respective signals.

In one specific embodiment of the present invention, multiple processors are provided instead of the one processor 205.

Processor 205 is designed for example to limit the specific functionality.

Processor 205 is designed for example to generate the result signals.

Processor 205 is designed for example to document one or multiple method steps.

Input 203 is designed for example to receive the aforementioned data.

Output 207 is designed for example to output the aforementioned data.

FIG. 3 shows a machine-readable storage medium 301 in accordance with an example embodiment of the present invention.

A computer program 303 is stored on machine-readable storage medium 301. The computer program 303 comprises commands that prompt a computer, when executing the computer program 303, to implement a method according to the second aspect.

According to one specific embodiment of the present invention, device 201 comprises a remote control device, which is designed to control the motor vehicle remotely on the basis of the generated remote control signals.

According to one specific embodiment of the present invention, an infrastructure or an infrastructure system is provided, which comprises for example the device according to the second aspect.

One specific embodiment of the present invention provides for the method to be carried out regularly, for example with a predetermined frequency.

One specific embodiment of the present invention provides for the method to be carried out continuously, that is constantly, that is without a break.

Example embodiment of the present invention described herein has in particular the advantage of making it possible to produce the motor vehicle more cheaply since it is only necessary to develop it for the “normal case” and no longer for “many/all” special cases (including cases of misuse).

One specific embodiment of the present invention provides for the method steps to be carried out inside the motor vehicle. The motor vehicle thus checks for itself whether the operating condition is fulfilled on the basis of the state.

One specific embodiment of the present invention provides for the method to be carried out inside the motor vehicle for other road users or for another road user. That is to say that the motor vehicle performs a check for another road user to determine whether the operating condition of the other road user if fulfilled, based on the state.

One specific embodiment of the present invention provides for many/all motor vehicles in a defined area, that is, within a predetermined limited geographic region, to perform the method steps. That is to say in particular that road users, in particular motor vehicles, in the defined area, check for themselves and/or for other road users whether the respective operating condition is fulfilled, based on the respective state.

One specific embodiment of the present invention provides for method steps to be performed by an external system, for example an infrastructure system. That is to say in particular that an external system checks whether the operating condition of a motor vehicle is fulfilled, based on the respective state.

In one specific embodiment of the present invention, in particular in the specific embodiment according to which many/all motor vehicles in a defined area perform the method steps and/or an external system performs the method steps, the respective results are made available to the other road users, in particular to the other motor vehicles.

One specific embodiment of the present invention provides for the step of checking to be performed in one or in multiple motor vehicles, that is, inside the vehicle, and/or outside the vehicle, for example in an infrastructure system, for example a cloud infrastructure.

One specific embodiment of the present invention provides for the motor vehicles and/or external systems to pass on intermediate results and/or results to respectively other systems/motor vehicles so that the respective other systems/motor vehicles are able to use these data to perform their own and specific analyses.

One specific embodiment of the present invention provides for one or more of the method steps to be performed redundantly. This advantageously further increases a safety in an efficient manner.

One specific embodiment of the present invention provides for the data, intermediate results, results and/or the actions (generation of control signals) resulting from the result to be documented in a blockchain, in particular in a manner that is comprehensible and secured against forgery.

In one specific embodiment of the present invention, the control signals are generated by the motor vehicle itself.

In one specific embodiment of the present invention, the control signals are generated by an external system.

In one specific embodiment of the present invention, the control signals are generated and/or checked both by the motor vehicle itself as well as by the external system.

A scenario is described below, in which example embodiments of the present invention described herein are applied:

A motor vehicle that is driven at least in partially automated fashion, in particular a shuttle, is for example allowed to be operated only in a specific area, for example a harbor. It is determined for example, for example by the motor vehicle itself and/or by an external system, that the motor vehicle is being operated in an area where operation is not allowed. Subsequently, the motor vehicle is blocked from further operation for example by itself or by an external system, in particular automatically. For example, the motor vehicle is stopped in at least partially automated fashion and is preferably stopped in a safe area.

A further scenario is described below, in which example embodiment of the present invention described herein are applied.

A motor vehicle, in particular a shuttle, is designed for example only for a defined speed range, within which speeds of further road users must range so that the motor vehicle may be driven in at least partially automated fashion. That is to say in particular that for example in the area the maximum speed of all road users must be within the defined speed range so that the motor vehicle may continue to be driven in at least partially automated fashion. For example, the maximum speed may be 30 km/h, in particular in a harbor. It is possible to provide a buffer in this context, for example an additional 10 km/h. If it is determined for example that other road users exceed this defined maximum speed (in particular when taking the buffer into account), then a further operation of the motor vehicle is limited and/or blocked, for example.

One specific embodiment of the present invention provides for a driver of the motor vehicle to be informed that an intervention into the driving operation of the motor vehicle has occurred and/or is occurring, that is, that the motor vehicle was controlled remotely and/or is being controlled remotely.

That is to say in particular that communication signals are generated and output, which represent a corresponding communication. The communication signals are output for example to a human-machine interface of the motor vehicle so that via the human-machine interface, based on the communication signals, the driver is informed about the intervention and/or the remote control.

One specific embodiment of the present invention provides for the intervention and/or the remote control of the motor vehicle to be communicated to an authority, so that the latter is able to initiate further steps for example.

According to one specific embodiment of the present invention, a condition for the remote control and/or for the intervention is that the remote control is safe. In the sense of the description, “safe” means in particular “safe” and “secure.” These two English terms are normally translated into German as “sicker.” In English, however, they have in part a different meaning.

The term “safe” pertains in particular to the topic of accident and accident avoidance. A remote control that is “safe” is one in which a probability of an accident or a collision is smaller than or smaller than/equal to a predetermined probability threshold value.

The term “secure” pertains in particular to the topic of computer protection and/or hacker protection, that is, in particular to how well a (computer) infrastructure and/or a communication infrastructure, in particular a communication link between a motor vehicle and a remote control device for controlling a motor vehicle remotely, is secured against unauthorized access and/or against data manipulations by third parties (“hackers”).

A remote control that is “secure” is thus in particular based on an appropriate and sufficient computer protection and/or hacker protection.

According to one specific embodiment of the present invention, for example, a check is performed to determine whether the totality made up of the motor vehicle and infrastructure involved in the method according to the first aspect including a communication between infrastructure and motor vehicle is currently safe for the concept “intervention in the motor vehicle for critical actions” described here. That is to say in particular that the motor vehicle and/or a local and/or a global infrastructure and/or a communication are checked accordingly. The remote control signals are generated on the basis of a result of the check.

This thus means in particular that the components used in the implementation of the method according to the first aspect are checked for safety, that is, whether they fulfill specific safety conditions, before the intervention into the driving operation is performed, that is, before the motor vehicle is controlled remotely.

Important and/or dependent criteria are for example one or several of the safety conditions described above.

One specific embodiment of the present invention provides that on the one hand the overall system (motor vehicle, infrastructure, communication link, cloud . . . ) is checked with respect to the safety condition.

One specific embodiment of the present invention provides the individual parts are also checked with respect to the safety condition being fulfilled. This in particular prior to controlling the motor vehicle remotely.

In one specific embodiment of the present invention, the step(s) of checking is/are performed inside the motor vehicle and/or outside the motor vehicle, in particular in an infrastructure.

One specific embodiment of the present invention provides for the step(s) of checking to be re-checked subsequently, that is, at a later point in time, for example regularly. For example, the step(s) of checking is/are re-checked subsequently at a predetermined frequency, for example every 100 ms.

This re-checking, that is, the re-checking to determine whether the at least one safety condition is fulfilled, occurs according to one specific embodiment prior to and/or after and/or during one or several predetermined method steps.

According to one specific embodiment of the present invention, the re-checking is performed or executed in the event of problems.

What is claimed is:

1. A method for driving a motor vehicle in at least partially automated fashion, comprising the following steps:
receiving operating condition signals, which represent an operating condition for the motor vehicle, which must be fulfilled so that the motor vehicle may be driven in at least partially automated fashion;
receiving state signals, which represent a state of the motor vehicle and/or of surroundings of the motor vehicle;
checking based on the state whether the operating condition is fulfilled to ascertain a result of the check;
generating control signals for controlling a lateral and/or longitudinal guidance of the motor vehicle in at least partially automated fashion based on the result of the check to drive the motor vehicle based on the generated control signals in at least partially automated fashion; and
outputting the generated control signals.

2. The method as recited in claim 1, wherein the motor vehicle has a specific functionality with respect to the at least partially automated driving, the specific functionality being limited or unlimited, the specific functionality being limited when the result of the check indicates that the condition is not fulfilled, the control signals being produced based on the limited specific functionality instead of on the unlimited specific functionality to drive the motor vehicle in at least partially automated fashion based on the limited specific functionality.

3. The method as recited in claim 2, wherein the specific functionality includes a first maximum motor vehicle speed and/or first maximum motor vehicle acceleration, which the motor vehicle may maximally exhibit when it is driven in at least partially automated fashion, the limitation of the specific functionality includes a definition of a second maximum motor vehicle speed and/or second maximum motor vehicle acceleration, which is lower than the first maximum motor vehicle speed and/or first maximum motor vehicle acceleration so that the limited specific functionality includes the second maximum motor vehicle speed and/or the second maximum motor vehicle acceleration.

4. The method as recited in claim 2, wherein the specific functionality includes a first minimum distance of the motor vehicle from a preceding motor vehicle traveling ahead, which the motor vehicle must maintain when the motor vehicle is driven in at least partially automated fashion, the limitation of the specific functionality includes a definition of a second minimum distance, which is greater than the first minimum distance so that the limited specific functionality includes the second minimum distance.

5. The method as recited in claim 2, wherein the specific functionality includes a passing function so that the motor vehicle is able to perform a passing maneuver in at least partially automated fashion, the limitation of the specific functionality including a limitation or blocking of the passing functionality so that the limited specific functionality includes the limited passing functionality or excludes the passing functionality.

6. The method as recited in claim 1, wherein result signals are generated and output that represent the result of the check.

7. The method as recited in claim 6, wherein the output of the result signals includes a transmission of the result signals via a communication network.

8. The method as recited in claim 1, wherein the operating condition specifies that the motor vehicle may only be driven in at least partially automated fashion within a predetermined limited geographic area, the state indicating a current position of the motor vehicle, the check including checking whether the current position of the motor vehicle is within the predetermined limited geographic area.

9. The method as recited in claim 1, wherein the operating condition specifies a maximum speed for road users in an environment of the motor vehicle, which the road users may maximally have so that the motor vehicle is permitted to be driven in at least partially automated fashion in an environment of road users, the state indicating a current speed of at least one of the road users in the environment of the motor vehicle, the check including a check to determine whether the current speed of the road user is lower than or lower than/equal to the maximum speed.

10. The method as recited in claim 1, wherein the operating condition specifies a maximum acceleration for road users in an environment of the motor vehicle, which the road users may maximally exhibit so that the motor vehicle is permitted to be driven in at least partially automated fashion in an environment of road users, the state indicating a current acceleration of at least one of the road users in the environment of the motor vehicle, the check including a check to determine whether the current acceleration of the road user is lower than or lower than/equal to the maximum acceleration.

11. The method as recited in claim 1, wherein the control signals including and/or are at least in part remote control signals for controlling the lateral and/or longitudinal guidance of the motor vehicle remotely in order to control the lateral and/or longitudinal guidance of the motor vehicle remotely when the motor vehicle is controlled remotely based on the remote control signals.

12. The method as recited in claim 11, wherein safety condition signals are received which represent at least one safety condition that must be fulfilled so that the motor vehicle may be controlled remotely, a further check being performed to determine whether the at least one safety condition is fulfilled, the remote control signals being generated based on a result of the further check as to whether the at least one safety condition is fulfilled.

13. The method as recited in claim 12, wherein the at least one safety condition is respectively an element selected from the following group of safety conditions:
(i) existence of a predetermined safety integrity level or automotive safety integrity level of at least the motor vehicle and an infrastructure, including a communication link and/or communication components, for controlling a motor vehicle remotely;
(ii) existence of a maximum latency of a communication between the motor vehicle and a remote control device for controlling the motor vehicle remotely based on the remote control signals;
(iii) existence of a predetermined computer protection level of a device for performing the steps of the method;
(iv) existence of predetermined components and/or algorithms and/or communication options that are used for performing the steps of the method;
(v) existence of a redundancy and/or diversity in predetermined components and/or algorithms and/or communication options that are used for performing the steps of the method;
(vi) existence of predetermined availability information, which indicates an availability of predetermined components and/or algorithms and/or communication options:
(vii) existence of predetermined quality criteria of the predetermined components and/or algorithms and/or communication options;
(viii) existence of a plan which includes measures for reducing errors and/or measures in the event of failures of predetermined components and/or algorithms and/or communication options and/or measures for misdiagnoses and/or measures in the event of misinterpretations;
(ix) existence of one or multiple fallback scenarios;
(x) existence of a predetermined function;
(xi) existence of a predetermined traffic situation,
(xii) existence of a predetermined weather, maximally possible time for a respective implementation and/or execution of one or more steps of the method;
(xiii) existence of a result of a check to determine that elements and/or functions, which are used for carrying out the method currently function in a faultless manner.

14. The method as recited in claim 12, wherein the remote control signals are generated only when the at least one safety condition is fulfilled.

15. The method as recited in claim 12, wherein the check to determine whether the at least one safety condition is fulfilled occurs prior to and/or after and/or during one or several predetermined ones of the method steps.

16. The method as recited in claim 12, wherein, following the output of the remote control signals, a remote control of the motor vehicle based on the output remote control signals is re-checked in order to detect an error, the remote control being aborted in an event that an error is detected or emergency remote control signals for controlling the motor vehicle remotely in an emergency being generated and output.

17. The method as recited in claim 1, wherein, when the result of the check indicates that the condition is not fulfilled, the control signals are generated in such a way that the motor vehicle stops within a predetermined space, when the lateral and/or longitudinal guidance of the motor vehicle is controlled based on the generated control signals.

18. The method as recited in claim 1, wherein one or more of the method steps are performed within the motor vehicle and/or outside the motor vehicle.

19. The method as recited in claim 1, wherein one or more of the method steps are performed in an additional motor vehicle, and/or in an infrastructure, and/or in a cloud infrastructure.

20. The method as recited in claim 19, wherein one or multiple of the method steps are performed by a further motor vehicle only when the further motor vehicle is located within the same predetermined limited geographic area as the motor vehicle.

21. The method as recited in claim 18, wherein data, which are used for performing one or multiple of the method steps, are exchanged and/or provided between an exterior of the motor vehicle and an interior of the motor vehicle.

22. The method as recited in claim 1, wherein one or multiple of the method steps are documented in a blockchain.

23. The method as recited in claim 1, wherein a check is performed to determine whether a totality made up of the motor vehicle and of infrastructure involved in the method including a communication between the infrastructure and the motor vehicle is secure so that the motor vehicle and/or a local infrastructure and/or a global infrastructure and/or a communication between motor vehicle and infrastructure are checked accordingly.

24. A device configured to drive a motor vehicle in at least partially automated fashion, the device configured to:
receive operating condition signals, which represent an operating condition for the motor vehicle, which must be fulfilled so that the motor vehicle may be driven in at least partially automated fashion;
receive state signals, which represent a state of the motor vehicle and/or of surroundings of the motor vehicle;
check based on the state whether the operating condition is fulfilled to ascertain a result of the check;
generate control signals for controlling a lateral and/or longitudinal guidance of the motor vehicle in at least partially automated fashion based on the result of the check to drive the motor vehicle based on the generated control signals in at least partially automated fashion; and
output the generated control signals.

25. A non-transitory machine-readable storage medium on which is stored a computer program for driving a motor vehicle in at least partially automated fashion, the computer program, when executed by a computer, causing the computer to perform the following steps:
receiving operating condition signals, which represent an operating condition for the motor vehicle, which must be fulfilled so that the motor vehicle may be driven in at least partially automated fashion;
receiving state signals, which represent a state of the motor vehicle and/or of surroundings of the motor vehicle;
checking based on the state whether the operating condition is fulfilled to ascertain a result of the check;
generating control signals for controlling a lateral and/or longitudinal guidance of the motor vehicle in at least partially automated fashion based on the result of the check to drive the motor vehicle based on the generated control signals in at least partially automated fashion; and
outputting the generated control signals.
